(19) United States
(12) Patent Application Publication
(10) Pub. No.: US 2016/0358528 A1
(43) Pub. Date: Dec. 8, 2016

(54) TIME COMPENSATION-BASED LED SYSTEM

(71) Applicant: TEXAS INSTRUMENTS INCORPORATED, Dallas, TX (US)

(72) Inventors: MAKALO XIE, SHENZHEN (CN); MIKE WANG, SHANGHAI (CN); DEVIS LIN, SHENZHEN (CN)

(21) Appl. No.: 14/569,154

(22) PCT Filed: Feb. 28, 2014
(86) PCT No.: PCT/CN2014/072690

§ 371 Date: Dec. 12, 2014

(51) Int. Cl. G09G 3/20; G09G 3/3208

(52) U.S. Cl. CPC G09G 3/2018; G09G 3/3208; G09G 2310/08; G09G 2320/0242

(57) ABSTRACT

One example includes a light-emitting diode (LED) system. The LED system includes an LED array comprising a plurality of LEDs that are each activated to provide an LED current therethrough to provide illumination in one of a plurality of colors. The LED system also includes an LED controller configured to activate the plurality of LEDs based on a digital input comprising grayscale data corresponding to activation of the plurality of LEDs and further comprising compensation time data corresponding to an activation pulse-width of each of the plurality of LEDs based on a respective one of the plurality of colors of the respective each one of the plurality of LEDs to maintain a substantially equal activation time of the plurality of LEDs.

### RELATED APPLICATIONS

The present invention is a U.S. National Stage under 35 USC 371 patent application, claiming priority to Serial No. PCT/CN2014/072690, filed on 28 Feb. 2014, the entirety of which is incorporated herein by reference.

### TECHNICAL FIELD

This disclosure relates generally to electronic circuit systems, and more specifically to a time compensation-based LED system.

### BACKGROUND

The use of light-emitting diode (LED) strings instead of fluorescent bulbs for use in illumination of a backlight for a display, such as a television, a monitor for a laptop computer, or an LED display wall, is increasing drastically based on consumer demands for better picture quality. In addition, typical LED light efficacy can be much better than conventional lighting systems for such displays, thus consuming significantly less power. In addition, among other advantages, LED systems can be smaller and more environmentally friendly, and can have a faster response with less electro-magnetic interference (EMI) emissions. A number of LED regulation techniques exist for typical LED display systems. A typical LED display system that can be implemented for a display can utilize different colored LEDs, such as red, green, and blue, that can be combined to display trillions of different colors. However, based on the physical characteristics of the different colored LEDs relative to each other, the LEDs can be biased from different voltage magnitudes. As a result, the display can experience a lack of uniformity in the colors across the display, such as in a low grayscale environment.

### SUMMARY

One example includes a light-emitting diode (LED) system. The LED system includes an LED array comprising a plurality of LEDs that are each activated to provide an LED current therethrough to provide illumination in one of a plurality of colors. The LED system also includes an LED controller configured to activate the plurality of LEDs based on a digital input comprising grayscale data corresponding to activation of the plurality of LEDs and further comprising compensation time data corresponding to an activation pulse-width of each of the plurality of LEDs based on a respective one of the plurality of colors of the respective each one of the plurality of LEDs to maintain a substantially equal activation time of the plurality of LEDs.

Another example includes a method for activating a light-emitting diode (LED) in an LED system. The method includes receiving a digital input comprising grayscale data that defines a nominal activation pulse-width for the LED and compensation time data that defines an additional activation pulse-width for the LED. The method also includes calculating a compensation time that defines an activation pulse-width of the LED based on the compensation time data. The method also includes generating an activation signal associated with the LED having a pulse duration that is equal to a sum of the nominal activation pulse-width and the compensation time. The method further includes activating the LED via the activation signal.

Another embodiment includes an LED system. The system includes an LED array comprising a plurality of LEDs. The plurality of LEDs includes red LEDs, green LEDs, and blue LEDs that are each activated to provide an LED current therethrough to provide illumination. The system further includes an LED controller configured to receive a digital input comprising grayscale data and compensation time data. The LED controller includes a compensation time controller configured to calculate a compensation time corresponding to an increased activation pulse-width for the green LEDs and the blue LEDs relative to an activation pulse-width for the red LEDs based on the compensation time data. The LED controller also includes an activation controller configured to generate activation signals for the red, green, and blue LEDs having the respective activation pulse-widths based on the grayscale data and the compensation time. The LED controller further includes a plurality of LED drivers configured to activate the red, green, and blue LEDs based on the activation signals.

### BRIEF DESCRIPTION OF THE DRAWINGS

FIG. 1 illustrates an example of an LED system.

FIG. 2 illustrates another example of an LED system.

FIG. 3 illustrates an example of an LED controller.

FIG. 4 illustrates an example of a timing diagram.

FIG. 5 illustrates another example of a timing diagram.

FIG. 6 illustrates an example of a display system.

FIG. 7 illustrates an example of a method for activating an LED in an LED system.

### DETAILED DESCRIPTION

This disclosure relates generally to electronic circuit systems, and more specifically to a time compensation-based LED system. An LED system includes an LED array and an LED controller. As an example, the LED array can include red LEDs, green LEDs, and blue LEDs, and can be implemented in an LED display system (e.g., a television, computer monitor, or LED display wall). The LED controller can receive a digital input that can include grayscale data corresponding to activation of the LEDs and compensation time data that can correspond to an additional activation pulse-width for green and/or blue LEDs relative to the red LEDs. As an example, the digital input can be provided from an associated image processor. The LED controller can include a compensation time controller configured to calculate a compensation time based on the compensation time data to provide a longer activation pulse-width for the green and/or blue LEDs relative to the red LEDs to provide a substantially equal activation time for each activated one of the red, green, and blue LEDs.

The LED controller can include a counter configured to count clock cycles of a clock signal relative to a pulse-width of a pulse signal that is received (e.g., from an image processor). The counter can thus calculate a reference time, such that the compensation time data can define a portion of the reference time that is added to a nominal activation pulse-width (e.g., as defined by grayscale data) for a given green or blue LED activation pulse-width. As an example, the nominal activation pulse-width can correspond to a pulse-width that can be associated with an ideal activation time for the LEDs. Therefore, based on a parasitic capacitance associated with each of the respective red, green, and blue LEDs, the duration of the activation for the respective LEDs can be adjusted differently, thus maintaining a substantially equal effective activation time for each of the LEDs to provide for a uniform illumination of the LEDs, such as in a low grayscale condition. As another example, the compensation time data can define an additional activation pulse-width for green and/or blue LEDs beyond the nominal activation pulse-width (e.g., which could be approximately equal to an activation pulse-width for the red LEDs). Therefore, the compensation time controller can add the additional activation pulse-width to the nominal activation pulse-width to provide the activation pulse-width for the green and/or blue LEDs. Additionally, the LED controller can further include an activation speed controller configured to set an activation speed of the LEDs, such as at a constant speed for red LEDs and at a speed that is dynamic and/or independent for the green and/or blue LEDs. Therefore, noise resulting from electro-magnetic interference (EMI) can be substantially mitigated.

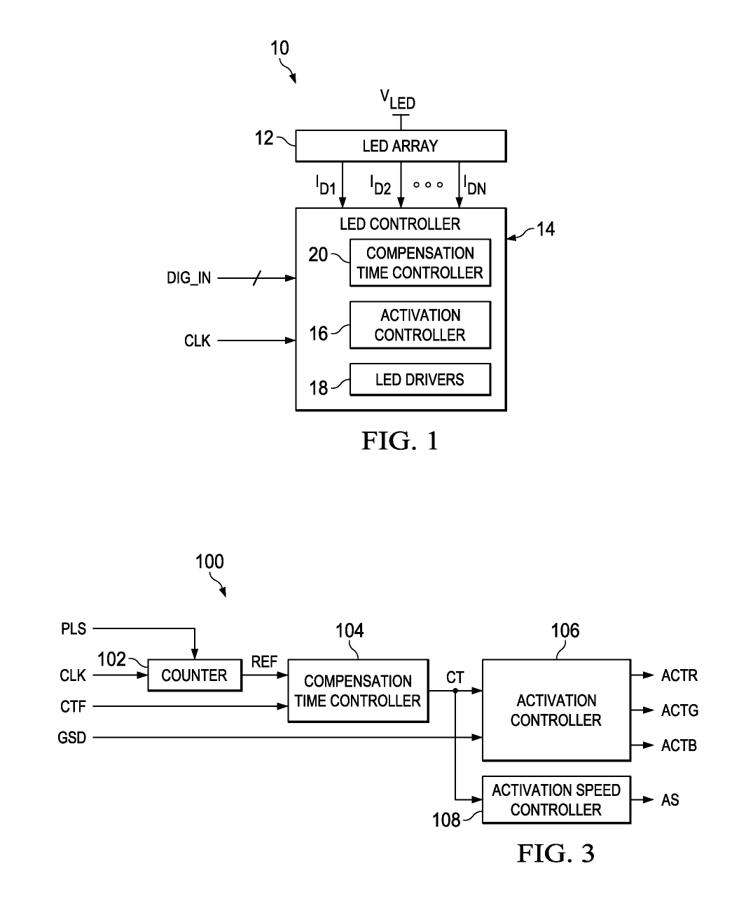

FIG. 1 illustrates an example of a light-emitting diode (LED) system 10. The LED system 10 can be implemented in a variety of display applications, such as in a computer monitor, television, or LED display wall. The LED system 10 includes an LED array 12 that includes a plurality of LEDs that provide illumination in a plurality of different colors. As an example, the LED array 12 can include red LEDs, green LEDs, and blue LEDs that are arranged in an array of rows and columns to provide the respective illumination for a display screen. The LED system 10 also includes an LED controller 14 that is configured to activate the LEDs in the LED array 12 in response to a digital input signal DIG_IN. As an example, the digital input signal DIG_IN can be provided from an image processor (not shown) that is configured to process image data to control activation of sets of the LEDs in the LED array 12 to display an associated image. As an example, the digital input signal DIG_IN can define nominal activation pulse-width(s) for the LEDs in the LED array 12.

In the example of FIG. 1, the LED controller 14 includes an activation controller 16 and a set of LED drivers 18. The activation controller 16 is configured to generate a set of activation signals based on the digital input DIG_IN, and the LED drivers 18 are configured to activate the LEDs in the LED array 12. As an example, the LED drivers 18 can be arranged as any of a variety of amplifier types that are switchably controlled to initiate a current flow through the LEDs in the LED array 12, demonstrated in the example of FIG. 1 as a plurality of currents I_{D1} through I_{DN}, where N is a positive integer. For example, each of the currents I_{D1} through I_{DN} can correspond to a separate respective channel associated with a column of LEDs in the LED array 12, such as scanned individually by row. Therefore, the LEDs in the LED array 12 can provide respective portions of illumination based on the currents I_{D1} through I_{DN}. In addition, in the example of FIG. 1, the LED controller 14 includes a compensation time controller 20 that is configured to set pulse-widths for activation respective activation signals for the LEDs in the LED array to provide approximately equal activation times for the LEDs, and thus substantial uniformity in illumination of the LEDs of all colors in the LED array, as described herein.

Due to physical characteristics of the different colored LEDs relative to each other, a forward-bias voltage of the different colored LEDs can be different relative to each other. For example, a forward-bias voltage of a red LED can be approximately between 1.8V and 2.5V, while a forward-bias voltage of a green or a blue LED can be approximately 2.8V and 3.5V. Therefore, red LEDs can have a smaller forward-bias threshold voltage than green and blue LEDs. As another example, green LEDs can typically have a smaller forward-bias threshold voltage than blue LEDs. Therefore, the turn-on time for red LEDs can be less (i.e., faster) than the turn-on time for green and blue LEDs given approximately equal LED current based on the activation voltage increasing to an associated threshold faster for red LEDs relative to green and blue LEDs. As described herein, the term “turn-on time” refers to a time duration between assertion of an activation pulse and a resulting activation of an associated LED based on a delay in the voltage across the LED increasing to a forward-bias threshold. As another example, green LEDs can likewise have a lesser (i.e., faster) turn-on time than blue LEDs. Therefore, given a constant activation pulse-width for red, green, and blue LEDs, and thus a constant time duration of an LED current for red, green, and blue LEDs, the difference in turn-on time can cause a different activation time for red LEDs relative to green and/or blue LEDs (e.g., and different time duration of green LEDs relative to blue LEDs). As described herein, the term “activation time” refers to a time duration that an LED is activated and providing illumination. As a result of the difference in activation times for red, green, and blue LEDs, an associated display can experience a non-uniformity, especially in low grayscale conditions, that can cause an undesired reddish hue in portions of the associated display.

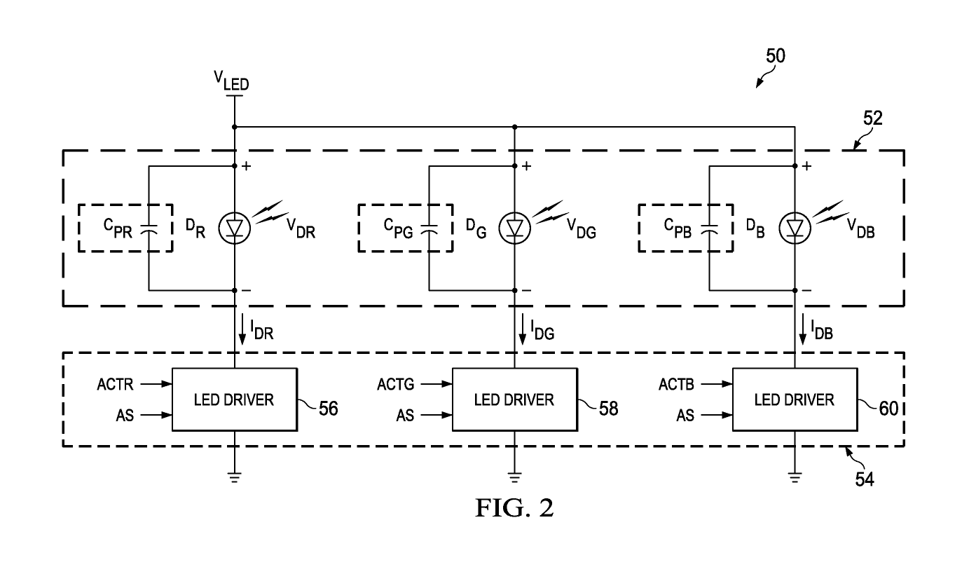

FIG. 2 illustrates another example of an LED system 50. The LED system 50 can correspond to the LED system 10 in the example of FIG. 1. Therefore, reference is to be made to the example of FIG. 1 in the following description of the example of FIG. 2.

The LED system 50 includes an LED array 52 that includes a red LED D_{R}, a green LED D_{G}, and a blue LED D_{B}. In the example of FIG. 2, the red LED D_{R}, the green LED D_{G}, and the blue LED D_{B} each receive power from an LED voltage V_{LED}. It is to be understood that the red LED D_{R}, the green LED D_{G}, and the blue LED D_{B} are demonstrated as the only LEDs in the LED array 52 for simplicity, but that the LED array 52 can include many more LEDs arranged in rows and columns, such as scanned by individual rows (e.g., in groups of eight rows). In the example of FIG. 2, the red LED D_{R} includes a parasitic capacitor C_{PR} that is arranged in parallel, the green LED D_{G} includes a parasitic capacitor C_{PG} that is arranged in parallel, and the blue LED D_{B} includes a parasitic capacitor C_{PB} that is arranged in parallel.

The LED system 50 also includes an LED controller 54 that includes a first LED driver 56 that is associated with the red LED D_{R}, a second LED driver 58 that is associated with the green LED D_{G}, and a third LED driver 60 that is associated with the blue LED D_{B}. The first LED driver 56 is activated in response to an activation signal ACTR to provide a current flow I_{DR} through the red LED D_{R}. Similarly, the second LED driver 58 is activated in response to an activation signal ACTG to provide a current flow I_{DG} through the green LED D_{G}, and the third LED driver 60 is activated in response to an activation signal ACTB to provide a current flow I_{DB} through the blue LED D_{B}. Additionally, in the example of FIG. 2, the LED drivers 56, 58, and 60 receive a signal AS corresponding to an activation speed, as described herein. For example, the signal AS can define a rate at which the respective currents I_{DR}, I_{DG}, and I_{DB}increase, such as to control electromagnetic interference (EMI) emissions associated with the LED controller 54, such as based on respective calculated compensation times. While the LED drivers 56, 58, and 60 are demonstrated as coupled to the single respective red, green, and blue LEDs D_{R}, D_{G}, and D_{B}, it is to be understood that the LED drivers 56, 58, and 60 can be coupled to a column of LEDs (e.g., a column of eight LEDs) of the same or different colors.

In response to the current I_{DR}, a forward-bias voltage V_{DR} is provided across the red LED D_{R} to illuminate the red LED D_{R}. In response to the current I_{DG}, a forward-bias voltage V_{DG} is provided across the green LED D_{G} to illuminate the green LED D_{G}. In response to the current I_{DB}, a forward-bias voltage V_{DB} is provided across the blue LED D_{B} to illuminate the blue LED D_{B}. Thus, based on the parasitic capacitors C_{PR}, C_{PG}, and C_{PB} across the respective red, green, and blue LEDs D_{R}, D_{G}, and D_{B}, the respective turn-on times T_{TR}, T_{TG}, and T_{TB} can be expressed, for example, as follows:

T_{TR}=C_{PR}*V_{DR}/I_{DR} Equation 1

T_{TG}=C_{PG}*V_{DG}/I_{DG} Equation 2

T_{TB}=C_{PB}*V_{DB}/I_{DB} Equation 3

Thus, an activation time T_{AR}, T_{AG}, and T_{AB} associated with the respective red, green, and blue LEDs can be expressed as follows:

T_{AR}=T_{ACTR}−T_{TR} Equation 4

T_{AG}=T_{ACTG}−T_{TG} Equation 5

T_{AB}=T_{ACTB}−T_{TB} Equation 6

Where:
T_{ACTR} corresponds to a pulse-width of the activation signal ACTR;
T_{ACTG} corresponds to a pulse-width of the activation signal ACTG; and
T_{ACTB} corresponds to a pulse-width of the activation signal ACTB.
   Therefore, Equations 1-6 demonstrate a relationship between the turn-on times T_{TR}, T_{TG}, and T_{TB}, the activation times T_{AR}, T_{AG}, and T_{AB}, and the pulse-widths T_{ACTR}, T_{ACTG}, and T_{ACTB} of the respective activation signals ACTR, ACTG, and ACTB. Because the forward-bias voltage V_{DR}, V_{DG}, and V_{DB} can be different relative to each other, and because the LED currents I_{DR}, I_{DG}, and I_{DB} can be different relative to each other, the turn-on times T_{TR}, T_{TG}, and T_{TB} can be different, with the turn-on time T_{TR} for red LEDs being the shortest. Therefore, given approximately equal pulse-widths T_{ACTR}, T_{ACTG}, and T_{ACTB} of the respective activation signals ACTR, ACTG, and ACTB, the activation time T_{AR} for the red LEDs can be the longest. As a result, the associated LED display can exhibit a reddish hue, particularly in low-grayscale conditions.

Referring back to the example of FIG. 1, the compensation time controller 20 can be configured to calculate a compensation time, such that the activation controller 16 can be configured to generate the activation signals (e.g., ACTR, ACTG, and ACTB) at appropriate pulse durations T_{ACTR}, T_{ACTG}, and T_{ACTB}, for example, to maintain substantially equal activation times T_{AR}, T_{AG}, and T_{AB} for the activated LEDs of the LED array 12. Accordingly, the associated display can be subject to substantial display uniformity, especially in low grayscale conditions. For example, the digital input DIG_IN can include grayscale data defining activation data associated with the LEDs in the LED array 12 (e.g., including nominal activation pulse-widths for the LEDs), and can include compensation time data associated with additional activation time for other color LEDs (e.g., green and/or blue LEDs) relative to red LEDs in the LED array 12. Thus, the compensation time controller 20 can calculate a compensation time based on the compensation time data in the digital input DIG_IN.

As an example, the activation controller 16 can add the compensation time to a nominal activation pulse-width, as defined by the grayscale data, to generate the pulse-widths corresponding to the activation of the green and/or blue LEDs (e.g., the pulse-widths T_{ACTG} and/or the T_{ACTB} of the activation signals ACTG and/or ACTB, respectively). In the example of FIG. 1, the LED controller 14 receives a clock signal CLK. As an example, the clock signal CLK can be generated by an external clock, or can be generated by a clock internal to the LED controller 14. The compensation time controller 20 can be configured to generate the compensation time for the other color LEDs of the LED array 12 based on cycles of the clock signal CLK, as described herein.

FIG. 3 illustrates an example of an LED controller 100. The LED controller 100 can correspond to the LED controllers 14 and 54 in the examples of FIGS. 1 and 2, respectively. Therefore, reference is to be made to the examples of FIGS. 1 and 2 in the following descriptions of the example of FIG. 3.

The LED controller 100 includes a counter 102 that receives the clock signal CLK and a pulse signal PLS, such as provided from an image controller (not shown). The counter 102 is configured, for example, to count a number of cycles of the clock signal CLK to determine a pulse-width of the pulse signal PLS. For example, the counter can determine the pulse-width based on a number of cycles that have transpired while the pulse signal PLS is asserted to determine the pulse-width of the pulse signal PLS. As described herein, the term “cycles” can be used to describe entire periods or partial periods (e.g., logic-high and logic-low portions) of a period of the clocks signal CLK. As described previously, the clock signal CLK can be provided from an external clock, or can be provided via a clock that is internal to the LED controller 100.

The counter 102 provides a reference signal REF corresponding to the pulse-width of the pulse signal PLS to a compensation time controller 104, such as corresponding to the compensation time controller 20 in the example of FIG. 1. The compensation time controller 104 also receives compensation time data CTF, such as can be included in or as a portion of the digital input DIG_IN. The compensation time controller 104 can thus be configured to calculate a compensation time for green and/or blue LEDs of the LED array 12. As an example, the compensation time factor data CTF can correspond to a variable that is multiplied and/or divided by the pulse-width defined by the reference signal REF to determine the compensation time for the green and/or blue LEDs. For example, the compensation time factor data CTF can correspond to a first multiplier for a compensation time for green LEDs and a second multiplier for a compensation time for blue LEDs. Thus, the compensation time controller 104 can calculate a compensation time CT_{G} for the green LEDs and a compensation time CT_{B} for the blue LEDs based on the reference signal REF multiplied by the first and second multipliers, respectively, divided by a constant, such as follows:

CT_{G}=REF*M/K Equation 7

CT_{B}=REF*N/K Equation 8
Where:
M corresponds to the first multiplier associated with the green LEDs, as defined by the compensation time data CTF;
N corresponds to the second multiplier associated with the blue LEDs, as defined by the compensation time data CTF;
K corresponds to a constant associated with a maximum value of the first and second multipliers (e.g., 32).

The LED controller 100 also includes an activation controller 106 that can correspond to the activation controller 16 in the example of FIG. 1. Thus, the activation controller 106 is configured to generate the activation signals ACTR, ACTG, and ACTB associated with the red LEDs, the green LEDs, and the blue LEDs, respectively, of the LED array 12. The activation controller 106 receives the compensation time(s) CT (e.g., including the compensation times CT_{G} and CT_{B}) from the compensation time controller 104, as well as grayscale data GSD, such as can be included in or as a portion of the digital input DIG_IN. As an example, the grayscale data GSD can include grayscale data GSD associated with each different color of LED in the LED array 12 (e.g., such as including a nominal activation pulse-width for each color of LED in the LED array 12). Thus, the activation controller 106 can thus calculate the pulse-widths of the activation signals ACTR, ACTG, and ACTB for each of the respective red LEDs, the green LEDs, and the blue LEDs of the LED array 12 based on the grayscale data GSD and the compensation time(s) CT. As an example, the grayscale data GSD can define a nominal pulse-width, such as approximately equal to the pulse-width T_{ACTR} for the red LEDs of the LED array 12. Therefore, the activation signal ACTR can have a pulse-width T_{ACTR} that is defined by the grayscale data GSD without additional compensation time. However, the activation controller 106 can be configured to add the compensation time(s) CT to the nominal pulse-width, as defined by the grayscale data GSD, to determine the activation pulse-width T_{ACTG} and/or T_{ACTB} for the green and/or blue LEDs, respectively, of the LED array 12. For example, the activation controller 106 can define the activation pulse-width T_{ACTG} for the activation signal ACTG and the activation pulse-width T_{ACTB} for the activation signal ACTB as follows:

T_{ACTG}=T_{ACTN}+CT_{G} Equation 9

T_{ACTB}=T_{ACTN}+CT_{B} Equation 10
Where: T_{ACTN} corresponds to a nominal pulse-width for the activation signals. As an example, T_{ACTN} can be approximately equal to T_{ACTR} for a set of grayscale data GSD that is common to the red, green, and blue LEDs.
   Accordingly, the activation controller 106 can generate the activation signals ACTR, ACTG, and ACTB as having the respective activation pulse-widths T_{ACTR}, T_{ACTG}, and T_{ACTB} for activation of the respective LEDs D_{R}, D_{G}, and D_{B} to maintain approximately equal activation times T_{AR}, T_{AG}, and T_{AB} for providing a substantially uniform illumination on an associated display in low grayscale.

In addition, in the example of FIG. 3, the LED controller 100 includes an activation speed controller 108 that is configured to control the activation speed of the LEDs D_{R}, D_{G}, and D_{B} based on the compensation time data CTF. As described herein, the term “activation speed” describes a linear or non-linear rate of activation of the LEDs D_{R}, D_{G}, and D_{B}, and thus defines the turn-on times T_{TR}, T_{TG}, and T_{TB} of the associated LEDs D_{R}, D_{G}, and D_{B}. As an example, the activation speed controller 108 can set an activation speed of the red LEDs at a constant rate, and can set an activation speed of each of the green and/or blue LEDs dynamically and independently, such as based on the calculated compensation time CT. For example, the activation speed controller 108 can set the activation speed of the green LEDs via the first multiplier M and activation speed of the blue LEDs via the second multiplier N, as provided in Equations 4 and 5. Furthermore, the activation speeds can be provided as slower for longer compensation times and faster for shorter compensation times, such that the red LEDs can have a shortest activation speed. The activation speed information is provided from the activation speed controller 108 as the signal AS that is provided to the LED drivers 56, 58, and 60 in the example of FIG. 2. As a result of controlling the activation speeds based on the compensation time CT, the EMI emission from the activation of the LEDs in the LED array can be substantially mitigated. As a result, an associated printed circuit board (PCB) that includes the LEDs of the LED array 12 can be designed in a more compact manner based on minimization of noise that can result in cross-talk between proximal sets of conductors.

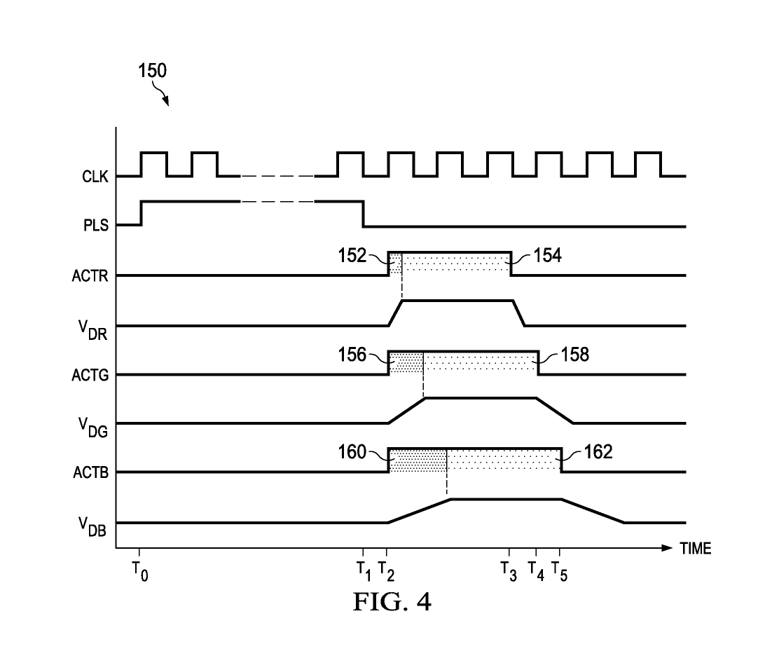

FIG. 4 illustrates an example of a timing diagram 150. The timing diagram 150 can correspond to timing of the signals described in the example of FIG. 3. Therefore, reference is to be made to the example of FIG. 3 in the following example of FIG. 4.

The timing diagram 150 demonstrates the clock signal CLK, the pulse signal PLS, the activation signal ACTR, the voltage V_{DR}, the activation signal ACTG, the voltage V_{DG}, the activation signal ACTB, and the voltage V_{DB}. At a time T₀, the pulse signal PLS is asserted from a logic-low state to a logic-high state, and at a time T₁, the pulse signal PLS is de-asserted from the logic-high state to the logic-low state. As described previously, the counter 102 can be configured to count cycles (e.g., periods or half periods) of the clock signal CLK to determine a pulse-width of the pulse signal PLS (i.e., from the time T₀ to the time T₁), which can be provided to compensation time controller 104 as the reference signal REF. Thus, along with the compensation time data CTF, the compensation time controller 104 can be configured to calculate the compensation time for the green LEDs D_{G} and the blue LEDs D_{B}. Thus, the compensation time controller 104 can provide the compensation times CT to the activation controller 106.

In response to receiving the compensation times CT, and in response to the grayscale data GSD, the activation controller 106 can generate the activation signals ACTR, ACTG, and ACTB. At a time T₂, the activation controller 106 asserts the activation signals ACTR, ACTG, and ACTB. In response to the assertion of the activation signals ACTR, ACTG, and ACTB, the voltages V_{DR}, V_{DG}, and V_{DB} begin to increase as the respective parasitic capacitors C_{PR}, C_{PG}, and C_{PB} are charged by the currents I_{DR}, I_{DG}, and I_{DB}. The slope of the voltages V_{DR}, V_{DG}, and V_{DB}, and thus the activation speeds of the LEDs D_{R}, D_{G}, and D_{B}, can be defined by the signal AS provided by the activation speed controller 108. As an example, the voltage V_{DR} across the red LED D_{R} can increase at a default rate, indicated as a relatively higher slope. The activation signal ACTR has a pulse-width T_{ACTR} that can be defined by a nominal activation time provided in the grayscale data GSD, demonstrated as a time duration from the time T₂ to a time T₃ (i.e., five half cycles of the clock signal CLK in the example of FIG. 4). Starting at the time T₂, the voltage V_{DR} increases to the forward-bias threshold and remains constant through the remainder of the activation signal ACTR. Thus, the increase of the voltage V_{DR} defines the turn-on time T_{TR} of the red LED D_{R}, demonstrated at 152. Thus, the remainder of the pulse-width T_{ACTR} corresponds to the activation time T_{AR}, demonstrated at 154. At the time T₃, the activation signal ACTR is de-asserted, and the voltage V_{DR} decreases at approximately the same speed as the activation speed (i.e., de-asserted at a slope that is approximately equal and opposite the increase of the voltage V_{DR} beginning at the time T₂).

Also at the time T₂, the voltage V_{DG} across the green LED D_{G} can increase at an activation speed that is based on the calculated compensation time CT_{G}, as provided by the signal AS via the activation speed controller 108. Therefore, the voltage V_{DG} can have less slope to provide for a slower activation speed of the green LED D_{G} relative to the red LED D_{R}. The activation signal ACTG has a pulse-width T_{ACTG}, demonstrated as a time duration from the time T₂ to a time T₄ (i.e., three full cycles of the clock signal CLK in the example of FIG. 4), that is longer than the pulse-width T_{ACTR} based on the inclusion of the compensation time CT_{G}. For example, the compensation time controller 104 can be configured to calculate the compensation time CT_{G} of the activation signal ACTG as a first portion of the pulse-width of the pulse signal PLS, as determined by the reference signal REF, such as based on the first multiplier M and the constant K taken as a fraction of the pulse-width of the pulse signal PLS. The compensation time CT_{G} can thus be added to the nominal pulse-width T_{ACTN} (e.g., equal to the pulse-width T_{ACTR} between the time T₂ and the time T₃) to provide the pulse-width T_{ACTG} of the activation signal ACTG. Starting at the time T₂, the voltage V_{DG} increases to the forward-bias threshold (which can be greater than the forward-bias threshold reached by the voltage V_{DR}) and remains constant through the remainder of the activation signal ACTG. Thus, the increase of the voltage V_{DG} defines the turn-on time T_{TG} of the green LED D_{G}, demonstrated at 156. Thus, the remainder of the pulse-width T_{ACTG} corresponds to the activation time T_{AG}, demonstrated at 158. At the time T₄, the activation signal ACTG is de-asserted, and the voltage V_{DG} decreases at approximately the same speed as the activation speed (i.e., de-asserted at a slope that is approximately equal and opposite the increase of the voltage V_{DG} beginning at the time T₂).

Also at the time T₂, the voltage V_{DB} across the blue LED D_{B} can increase at an activation speed that is based on the calculated compensation time CT_{B}, as provided by the signal AS via the activation speed controller 108. Therefore, the voltage V_{DB} can have less slope to provide for a slower activation speed of the blue LED D_{B} relative to the green LED D_{B}. The activation signal ACTB has a pulse-width T_{ACTB}, demonstrated as a time duration from the time T₂ to a time T₅ (i.e., seven half cycles of the clock signal CLK in the example of FIG. 4), that is longer than the pulse-widths T_{ACTR} and T_{ACTG} based on the inclusion of the compensation time CT_{B}. For example, the compensation time controller 104 can be configured to calculate the compensation time CT_{B} of the activation signal ACTB as a second portion of the pulse-width of the pulse signal PLS, as determined by the reference signal REF, such as based on the second multiplier N and the constant K taken as a fraction of the pulse-width of the pulse signal PLS. As described herein, the “first portion” and “second portion” of the pulse-width of the pulse signal PLS are not intended to denote mutually exclusive portions, but rather separate fractions of the pulse-width of the pulse signal PLS that could be equal. The compensation time CT_{B} can thus be added to the nominal pulse-width T_{ACTN} (e.g., equal to the pulse-width T_{ACTR} between the time T₂ and the time T₃) to provide the pulse-width T_{ACTB} of the activation signal ACTB. Starting at the time T₂, the voltage V_{DB} increases to the forward-bias threshold (which can be greater than the forward-bias threshold reached by the voltage V_{DB}) and remains constant through the remainder of the activation signal ACTB. Thus, the increase of the voltage V_{DB} defines the turn-on time T_{TB} of the blue LED D_{B}, demonstrated at 160. Thus, the remainder of the pulse-width T_{ACTB} corresponds to the activation time T_{AB}, demonstrated at 162. At the time T₅, the activation signal ACTB is de-asserted, and the voltage V_{DB} decreases at approximately the same speed as the activation speed (i.e., de-asserted at a slope that is approximately equal and opposite the increase of the voltage V_{DB} beginning at the time T₂).

Therefore, based on the separate pulse-widths T_{ACTR}, T_{ACTG}, and T_{ACTB} of the respective activation signals ACTR, ACTG, and ACTB, the red LEDs D_{R}, the green LEDs D_{G}, and the blue LEDs D_{B} can all have approximately equal activation times T_{AR}, T_{AG}, and T_{AB}. As a result, the LEDs D_{R}, D_{G}, and D_{B} can provide substantially uniform intensity across an associated display in a low grayscale condition. In the example of FIG. 4, while the voltages V_{DR}, V_{DG}, and V_{DB} decrease at the same speed as the respective activation speeds, it is to be understood that the voltages V_{DR}, V_{DG}, and V_{DB} are not intended to be limited to such. As an example, the voltages V_{DR}, V_{DG}, and V_{DB} can decrease statically at the same speed, or can be dynamically set in the same manner as the activation speed, such as based on the activation speed itself (e.g., based on the calculated compensation time CT).

Referring back to the example of FIG. 3, the function of the counter 102 to determine the pulse-width of the received pulse signal PLS is but one example of a manner in which the compensation time(s) CT can be calculated. As another example, the counter 102 can be omitted from the LED controller 100, such that the clock signal CLK is provided to the compensation time controller 104. In this example, the compensation time data CTF can include data associated with additional activation time, such as in cycles or portions of cycles of the clock signal CLK, corresponding to the compensation time that is to be added to the nominal pulse-width for the pulse-widths T_{ACTG} and T_{ACTB} for the respective activation signals ACTG and ACTB. Accordingly, in this example, the compensation time can be calculated without multiplication and division, and thus in a more computationally efficient manner. Additionally, the compensation time controller 104 can implement a second clock signal, such as generated based on multiplying the frequency of the clock signal CLK by a multiplication factor, to provide for finer increments of the compensation time(s) CT.

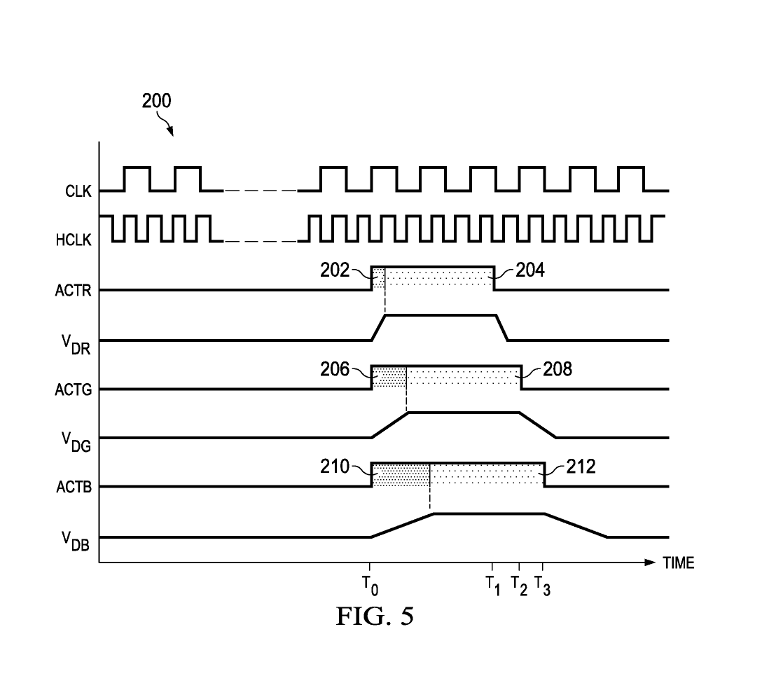

FIG. 5 illustrates another example of a timing diagram 200. The timing diagram 200 can correspond to timing of the signals described in the example of FIG. 3. Therefore, reference is to be made to the example of FIG. 3 in the following example of FIG. 5.

The timing diagram 200 demonstrates a first clock signal CLK, a second clock signal HCLK, the activation signal ACTR, the voltage V_{DR}, the activation signal ACTG, the voltage V_{DG}, the activation signal ACTB, and the voltage V_{DB}. In the example of FIG. 5, the second clock signal HCLK has a frequency that is approximately twice the frequency of the first clock signal CLK. As an example, the second clock signal HCLK can be generated based on multiplying the frequency of the first clock signal CLK by a multiplication factor (e.g., two). At a time prior to a time T₀, the compensation time controller 104 can have received the compensation time data CTF and can calculate the compensation time based on the compensation time data CTF, such as in units of half cycles of the second clock signal HCLK. Thus, the compensation time controller 104 can provide the compensation times CT to the activation controller 106.

In response to receiving the compensation times CT, and in response to the grayscale data GSD, the activation controller 106 can generate the activation signals ACTR, ACTG, and ACTB. At a time T₀, the activation controller 106 asserts the activation signals ACTR, ACTG, and ACTB. In response to the assertion of the activation signals ACTR, ACTG, and ACTB, the voltages V_{DR}, V_{DG}, and V_{DB} begin to increase as the respective parasitic capacitors C_{PR}, C_{PG}, and C_{PB} are charged by the currents I_{DR}, I_{DG}, and I_{DB}. The slope of the voltages V_{DR}, V_{DG}, and V_{DB}, and thus the activation speeds of the LEDs D_{R}, D_{G}, and D_{B}, can be defined by the signal AS provided by the activation speed controller 108. As an example, the voltage V_{DR} across the red LED D_{R} can increase at a default rate, indicated as a relatively higher slope. The activation signal ACTR has a pulse-width T_{ACTR} that can be defined by a nominal activation time provided in the grayscale data GSD, demonstrated as a time duration from the time T₀ to a time T₁ (i.e., nine half cycles of the second clock signal HCLK in the example of FIG. 5). Starting at the time T₀, the voltage V_{DR} increases to the forward-bias threshold and remains constant through the remainder of the activation signal ACTR. Thus, the increase of the voltage V_{DR} defines the turn-on time T_{TR} of the red LED D_{R}, demonstrated at 202. Thus, the remainder of the pulse-width T_{ACTR} corresponds to the activation time T_{AR}, demonstrated at 204. At the time T₁, the activation signal ACTR is de-asserted, and the voltage V_{DR} decreases at approximately the same speed as the activation speed (i.e., de-asserted at a slope that is approximately equal and opposite the increase of the voltage V_{DR} beginning at the time T₀).

Also at the time T₀, the voltage V_{DG} across the green LED D_{G} can increase at an activation speed that is based on the calculated compensation time CT_{G}, as provided by the signal AS via the activation speed controller 108. Therefore, the voltage V_{DG} can have less slope to provide for a slower activation speed of the green LED D_{G} relative to the red LED D_{R}. The activation signal ACTG has a pulse-width T_{ACTG}, demonstrated as a time duration from the time T₀ to a time T₂ (i.e., eleven half cycles of the second clock signal HCLK in the example of FIG. 5), that is longer than the pulse-width T_{ACTR} based on the inclusion of the compensation time CT_{G}. For example, the compensation time controller 104 can be configured to calculate the compensation time CT_{G} of the activation signal ACTG based on the first number of cycles of the second clock signal HCLK provided in the compensation time data CTF. The compensation time CT_{G} can thus be added to the nominal pulse-width T_{ACTN} (e.g., equal to the pulse-width T_{ACTR} between the time T₀ and the time T₁) to provide the pulse-width T_{ACTG} of the activation signal ACTG. Starting at the time T₀, the voltage V_{DG} increases to the forward-bias threshold (which can be greater than the forward-bias threshold reached by the voltage V_{DR}) and remains constant through the remainder of the activation signal ACTG. Thus, the increase of the voltage V_{DG} defines the turn-on time T_{TG} of the green LED D_{G}, demonstrated at 206. Thus, the remainder of the pulse-width T_{ACTG} corresponds to the activation time T_{AG}, demonstrated at 208. At the time T₂, the activation signal ACTG is de-asserted, and the voltage V_{DG} decreases at approximately the same speed as the activation speed (i.e., de-asserted at a slope that is approximately equal and opposite the increase of the voltage V_{DG} beginning at the time T₀).

Also at the time T₀, the voltage V_{DB} across the blue LED D_{B} can increase at an activation speed that is based on the calculated compensation time CT_{B}, as provided by the signal AS via the activation speed controller 108. Therefore, the voltage V_{DB} can have less slope to provide for a slower activation speed of the blue LED D_{B} relative to the green LED D_{B}. The activation signal ACTB has a pulse-width T_{ACTB}, demonstrated as a time duration from the time T₀ to a time T₃ (i.e., thirteen half cycles of the second clock signal HCLK in the example of FIG. 5), that is longer than the pulse-widths T_{ACTR} and T_{ACTG} based on the inclusion of the compensation time CT_{B}. For example, the compensation time controller 104 can be configured to calculate the compensation time CT_{B} of the activation signal ACTB based on the second number of cycles of the second clock signal HCLK provided in the compensation time data CTF. The compensation time CT_{B} can thus be added to the nominal pulse-width T_{ACTN} (e.g., equal to the pulse-width T_{ACTR} between the time T₀ and the time T₁) to provide the pulse-width T_{ACTB} of the activation signal ACTB. Starting at the time T₀, the voltage V_{DB} increases to the forward-bias threshold (which can be greater than the forward-bias threshold reached by the voltage V_{DB}) and remains constant through the remainder of the activation signal ACTB. Thus, the increase of the voltage V_{DB} defines the turn-on time T_{TB} of the blue LED D_{B}, demonstrated at 210. Thus, the remainder of the pulse-width T_{ACTB} corresponds to the activation time T_{AB}, demonstrated at 212. At the time T₃, the activation signal ACTB is de-asserted, and the voltage V_{DB} decreases at approximately the same speed as the activation speed (i.e., de-asserted at a slope that is approximately equal and opposite the increase of the voltage V_{DB} beginning at the time T₀).

Therefore, similar to as described previously, based on the separate pulse-widths T_{ACTR}, T_{ACTG}, and T_{ACTB} of the respective activation signals ACTR, ACTG, and ACTB, the red LEDs D_{R}, the green LEDs D_{G}, and the blue LEDs D_{B} can all have approximately equal activation times T_{AR}, T_{AG}, and T_{AB}. As a result, the LEDs D_{R}, D_{G}, and D_{B} can provide substantially uniform intensity across an associated display in a low grayscale condition. In the example of FIG. 5, while the voltages V_{DR}, V_{DG}, and V_{DB} decrease at the same speed as the respective activation speeds, it is to be understood that the voltages V_{DR}, V_{DG}, and V_{DB} are not intended to be limited to such. As an example, the voltages V_{DR}, V_{DG}, and V_{DB} can decrease statically at the same speed, or can be dynamically set in the same manner as the activation speed, such as based on the activation speed itself (e.g., based on the calculated compensation time CT).

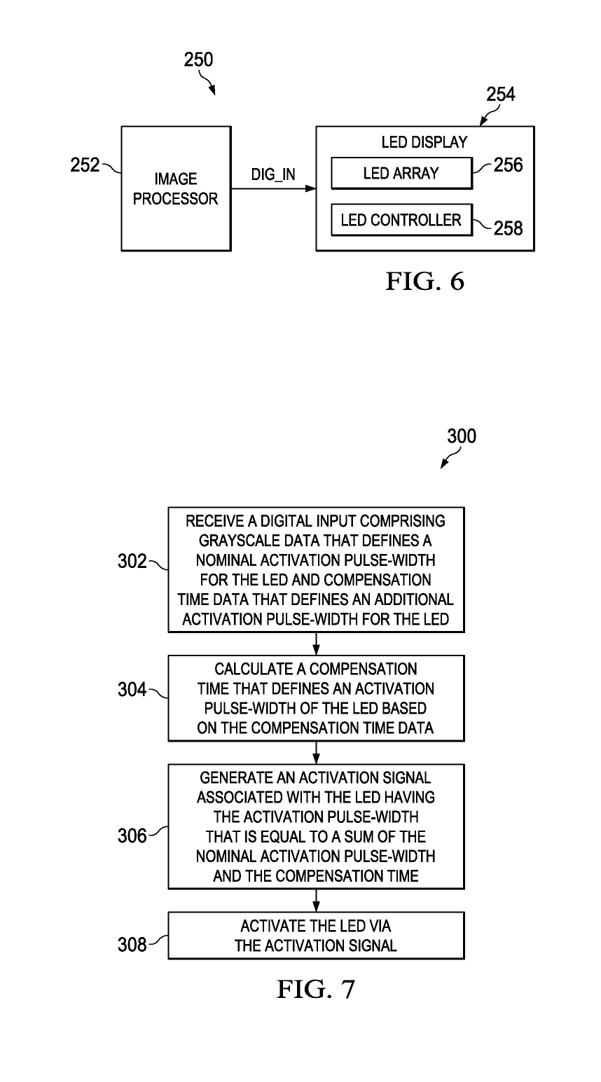

FIG. 6 illustrates an example of a display system 250. The display system 250 can correspond to a display system for a computer, such as for a computer monitor, or for an LED television. The display system 250 includes an image processor 252 that can be configured to generate image data, such as in response to a broadcast communication signal in a television system or from a processor in a computer system. The display system 250 also includes an LED display 254 that receives the image data, demonstrated as the digital input DIG_IN in the example of FIG. 6. As an example, the LED display 254 can be an LED television or a computer monitor. Similar to as described previously, the digital input DIG_IN can therefore include the grayscale data GSD and the compensation time data CTF that designates the additional pulse-width for the activation signals of the green and/or blue LEDs relative to the red LEDs. The LED display 254 includes an LED array 256, such as similar to the LED array 12 in the example of FIG. 1, and an LED controller 258, such as similar to the LED controller 14 in the example of FIG. 1 or the LED controller 100 in the example of FIG. 3. As a result, the LED controller 258 can implement the digital input DIG_IN to activate the LEDs in the LED array 256, such as based on a compensation time for LEDs of a color other than red. Accordingly, the LED display 254 can provide illumination in a substantially uniform manner, such as in a low grayscale condition, based on setting the activation times of the LEDs to be approximately equal, as described herein.

In view of the foregoing structural and functional features described above, certain methods will be better appreciated with reference to FIG. 7. It is to be understood and appreciated that the illustrated actions, in other embodiments, may occur in different orders and/or concurrently with other actions. Moreover, not all illustrated features may be required to implement a method.

FIG. 7 illustrates an example of a method 300 for activating an LED (e.g., the green LED D_{G} and/or the blue LED D_{B}) in an LED system (e.g., the LED system 10). At 302, a digital input (e.g., the digital input DIG_IN) comprising grayscale data (e.g., the grayscale data GSD) that defines a nominal activation time (e.g., an activation time for a red LED) for the LED and compensation time data (e.g., the compensation time data CTF) that defines an additional activation time for the LED is received. At 304, a compensation time (e.g., the compensation time(s) CT) that defines an activation time (e.g., the activation times T_{ACTR} and/or T_{ACTG}) of the LED is calculated based on the compensation time data. At 306, an activation signal (e.g., the activation time ACTG and/or ACTB) associated with the LED is generated having the activation time that is equal to a sum of the nominal activation time and the compensation time. At 308, the LED is activated via the activation signal.

What have been described above are examples of the invention. It is, of course, not possible to describe every conceivable combination of components or method for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A light-emitting diode (LED) system comprising:
an LED array comprising a plurality of LEDs that are each activated to provide an LED current therethrough to provide illumination in one of a plurality of colors; and
an LED controller configured to activate the plurality of LEDs based on a digital input comprising grayscale data corresponding to activation of the plurality of LEDs and further comprising compensation time data corresponding to a pulse-width of activation of each of the plurality of LEDs based on a respective one of the plurality of colors of the respective each one of the plurality of LEDs to maintain a substantially equal activation time for the plurality of LEDs.

2. The system of claim 1, wherein the LED controller comprises:
a compensation time controller configured to calculate a compensation time corresponding to an increased activation pulse-width for at least one of green and blue LEDs of the plurality of LEDs relative to an activation pulse-width for red LEDs of the plurality of LEDs based on the received compensation time data; and
an activation controller configured to generate activation signals for the red, green, and blue LEDs having the respective activation pulse-widths based on the grayscale data and the compensation time.

3. The system of claim 2, wherein the LED controller comprises a counter configured to count cycles of a clock signal to determine a pulse-width of a received pulse signal, wherein the compensation time data comprises a variable defining the compensation time as a portion of the received pulse signal, wherein the activation controller is configured to add the portion of the received pulse signal to a nominal activation pulse-width, as defined by the grayscale data, to define the activation pulse-width associated with at least one of the green and blue LEDs.

4. The system of claim 3, wherein the variable comprises a first variable defining the compensation time for the green LEDs as a first portion of the received pulse signal and a second variable defining the compensation time for the blue LEDs as a second portion of the received pulse signal, wherein the activation controller is configured to add the first portion of the received pulse signal to the nominal activation pulse-width to define the activation pulse-width associated with the green LEDs and to add the second portion of the received pulse signal to the nominal activation pulse-width to define the activation pulse-width associated with the blue LEDs.

5. The system of claim 2, wherein the compensation time data defines the compensation time as an additional pulse-width based on a number of cycles of a clock signal, wherein the activation controller is configured to add the additional pulse-width to a nominal activation pulse-width, as defined by the grayscale data, to define the activation pulse-width associated with at least one of the green and blue LEDs.

6. The system of claim 5, wherein the compensation time data defines a first additional activation pulse-width for the green LEDs and a second additional activation pulse-width for the blue LEDs, wherein the activation controller is configured to add the first additional activation pulse-width to the nominal activation pulse-width to define the activation pulse-width associated with the green LEDs and to add the second additional activation pulse-width to the nominal activation pulse-width to define the activation pulse-width associated with the blue LEDs.

7. The system of claim 5, wherein the clock signal is a first clock signal associated with the LED controller, wherein the LED controller comprises a frequency multiplier configured to generate a second clock signal based on the first clock signal and having a higher frequency than the first clock signal, wherein the duration factor data defines the compensation time as an additional activation pulse-width based on a number of cycles of the second clock signal.

8. The system of claim 1, wherein the LED controller comprises an activation speed controller configured to set an activation speed of the plurality of LEDs based on the compensation time data.

9. The system of claim 8, wherein the activation speed controller is configured to set the activation speed for red LEDs of the plurality of LEDs at a constant speed, and configured to separately and dynamically set the activation speed for each of green LEDs and blue LEDs of the plurality of LEDs based on the compensation time data.

10. An LED display system comprising the LED system of claim 1.

11. A method for activating a light-emitting diode (LED) in an LED system, the method comprising:
receiving a digital input comprising grayscale data that defines a nominal activation pulse-width for the LED and compensation time data that defines an additional activation pulse-width for the LED;
calculating a compensation time that defines an activation pulse-width of the LED based on the compensation time data;
generating an activation signal associated with the LED having the activation pulse-width that is equal to a sum of the nominal activation pulse-width and the compensation time; and
activating the LED via the activation signal.

12. The method of claim 11, wherein the LED is a green LED or a blue LED, wherein the grayscale data defines the nominal activation pulse-width as approximately equal to an activation pulse-width for a red LED in the LED system.

13. The method of claim 11, wherein calculating the compensation time comprises:
receiving a pulse signal having a defined pulse-width;
counting cycles of a clock signal to determine the defined pulse-width of the pulse signal;
calculating the compensation time as a portion of the defined pulse-width based on the compensation time data.

14. The method of claim 11, wherein the compensation time data defines the compensation time as an additional activation pulse-width based on a number of cycles of a clock signal, wherein calculating the compensation time comprises adding the number of cycles of the clock signal to the nominal activation pulse-width.

15. The method of claim 14, wherein the clock signal is a first clock signal associated with the LED controller, wherein the method further comprises, multiplying a frequency of the first clock signal by a multiplication factor to generate a second clock signal having a higher frequency than the first clock signal, wherein calculating the compensation time comprises adding the number of cycles of the second clock signal to the nominal activation pulse-width.

16. The method of claim 11, further comprising dynamically setting an activation speed of the plurality of LEDs based on the compensation time data.

17. A light-emitting diode (LED) system comprising:
an LED array comprising a plurality of LEDs, the plurality of LEDs comprising red LEDs, green LEDs, and blue LEDs that are each activated to provide an LED current therethrough to provide illumination; and
an LED controller configured to receive a digital input comprising grayscale data and compensation time data, the LED controller comprising:
a compensation time controller configured to calculate a compensation time corresponding to an increased activation pulse-width for the green LEDs and the blue LEDs relative to an activation pulse-width for the red LEDs based on the compensation time data;
an activation controller configured to generate activation signals for the red, green, and blue LEDs having the respective activation pulse-width based on the grayscale data and the compensation time; and
a plurality of LED drivers configured to activate the red, green, and blue LEDs based on the activation signals.

18. The system of claim 17, wherein the LED controller further comprises a counter configured to count cycles of a clock signal to determine a pulse-width of a received pulse signal, wherein the compensation time data comprises duration factor data defining the compensation time as a portion of the received pulse signal, wherein the activation controller is configured to add the portion of the received pulse signal to the nominal activation pulse-width as defined by the grayscale data, to define the activation pulse-width associated with the green and blue LEDs.

19. The system of claim 17, wherein the compensation time data comprises duration factor data defining the compensation time as an additional activation pulse-width based on a number of cycles of a clock signal, wherein the activation controller is configured to add the additional activation pulse-width to the nominal activation pulse-width, as defined by the grayscale data, to define the activation pulse-width associated with at least one of the green and blue LEDs.

20. The system of claim 17, wherein the LED controller comprises an activation speed controller configured to set the activation speed for the red LEDs at a constant speed, and configured to separately and dynamically set the activation speed for each of the green and blue LEDs based on the compensation time data.
